(19) United States
(12) Patent Application Publication
(10) Pub. No.: US 2009/0260522 A1
(43) Pub. Date: Oct. 22, 2009

(54) Portafilter for espresso machine

(76) Inventors: Jens Brine, Malmo (SE); Aldo Castiglione, Skanor (SE)

Correspondence Address: HARNESS, DICKEY & PIERCE, P.L.C., P.O.BOX 8910, RESTON, VA, 20195, US

(21) Appl. No.: 12/311,070

(22) PCT Filed: Sep. 20, 2007
(86) PCT No.: PCT/SE2007/000824

§ 371 Date: Jun. 2, 2009

Related U.S. Application Data
(60) Provisional application No. 60/845,773, filed on Sep. 20, 2006.

(30) Foreign Application Priority Data
Sep. 20, 2006 (SE) 0601935-0

(51) Int. Cl. A47J 31/06

(52) U.S. Cl. 99/298; 99/323

(57) ABSTRACT

The present invention relates to portafilter (1) for an espresso machine, which portafilter (1) is made of brass and comprises an inner surface, wherein the inner surface of the portafilter is coated first with a layer of primer (2) and then a layer of fluoropolymer (3) and wherein the layer of primer (2) enables attachment of the layer of fluoropolymer (3) to the inner surface of the portafilter (1).

### TECHNICAL FIELD

The present invention relates to a portafilter for an espresso machine, which portafilter is made of brass and comprises an inner surface.

### BACKGROUND OF THE INVENTION

Portafilters are known to be used for espresso machines which are manual or semi-automatic. The fully automatic espresso machines, however, is not used with portafilters. On the inside of a portafilter a filter basket is positioned containing coffee grounds through which hot water is fed to produce the coffee product, i.e. espresso. The normal way for making espresso by an espresso machine is to dose 7-25 grams of coffee grounds into the filter basket, compressing the coffee in order to get a correct infusion and hot water is fed through the machine at a temperature of 80-115°, preferably 90-100°, with a pressure of about 9 bar. The extraction time is normally between 18-30 seconds.

Brass is without comparison the most commonly used material for portafilters according to the state of the art. Brass is an alloy of copper and first and foremost zinc. The zinc content of brass is usually about 5-45 wt %. At a lower zinc content, that is at a higher copper content, the brass is more reddish and therefore called red copper. At higher contents of zinc the brass becomes more yellowish. In this description, the term “brass” should be interpreted to include both what is normally defined as brass as well as what is defined as red copper.

Brass portafilters according to the state of the art are made as one piece, that is without a coating on the inside. This means that, when making espresso, the hot espresso (water/steam/coffee) is in contact with the brass, which affects the taste negatively due to corrosion of the brass and/or ions precipitating from the brass into the finished espresso. These portafilters without an additional coating on the inside are hereinafter referred to as “brass portafilters according to state of the art” or “brass portafilters”.

In addition to the problem with the taste of the finished coffee product (espresso), the brass portafilters according to state of the art have to be cleaned often because of deposition onto the inside of these portafilters.

The filter basket of a portafilter comprises several small cylindrical holes through which the espresso is to be fed by compressing the coffee grounds. Some residues of fat and cellulose from the coffee penetrate these holes and deposit on the inside of the portafilter. There is much aroma in these residues which are beneficial for the taste of the finished espresso. However, as mentioned, with the brass portafilters according to state of the art these residues as well as the espresso interact with the brass metal and due to corrosion and ion precipitation, the taste of the finished espresso product is deteriorated. Moreover, wear and tear of the filter basket over time makes the holes of the filter basket more conical shaped. Due to this, whole coffee particles, in addition to the fat and cellulose of the coffee, can penetrate these holes. These particles stick to the fat coating on the inside of the brass portafilter. In other words, this coating or deposition makes the portafilter difficult to clean, and the interaction between the brass and the coating as well as the espresso deteriorates the taste of the finished espresso.

### SUMMARY OF THE INVENTION

The present invention aims at solving the problem with the deteriorated taste of the coffee product, i.e. espresso, which is a fact when using brass portafilters according to state of the art. Furthermore, the cleaning procedure which has to be performed with brass portafilters according to state of the art, is not a necessity as often and is a much easier procedure to perform with a portafilter according to the present invention.

The objects of the present invention are achieved by a portafilter for an espresso machine, which portafilter is made of brass and comprises an inner surface, wherein the inner surface is coated first with a layer of primer and then a layer of fluoropolymer and wherein the layer of primer enables attachment of the layer of fluoropolymer to the inner surface of the portafilter.

In view of the fact that the brass portafilter according to the present invention is coated with fluoropolymers, the espresso (water/steam/coffee) is not in contact with brass when the portafilter is used for making espresso. The fluoropolymers according to the present invention are much more corrosion resistant materials than brass or red copper, which gives a better taste of the coffee product and a longer shelf life of the portafilter.

Moreover, the fluoropolymer surface of the inside of a portafilter according to the present invention is not prone to be deposited with coffee particles in the same way as brass portafilters according to state of the art. As the portafilters according to the present invention are coated on the inside with a non-brass material they are much easier to clean as the fat do not stick to the inside as much as is the case of brass portafilters according to state of the art.

The portafilters according to the present invention are in other words easier to clean, do not have to be cleaned as often and the finished coffee product is not taste affected in the same way as with brass portafilters according to state of the art.

### DESCRIPTION OF THE DRAWING

FIG. 1. shows a portafilter according to the present invention. The inner surface of the solid brass portafilter 1 is first coated with a layer of primer 2, and then a layer of fluoropolymer 3. The layer of primer 2 is used to attach the layer of fluoropolymer 3. The filter basket 4, e.g. often made of stainless steel, contains the coffee grounds 5 through which hot water is fed. The finished coffee product 6, i.e. espresso, is poured into suitable coffee cups, in this case two espresso cups.

### DETAILED DESCRIPTION OF THE INVENTION

Different fluoropolymers are possible as coatings according to the present invention. According to one preferred embodiment of the present invention the fluoropolymer is a fluoropolymer which is accepted to be used in food applications. Examples of suitable fluoropolymers are fluoropolymers chosen from the group consisting of a polytetrafluoroethylene (PTFE) polymer, perfluoroalkoxy (PFA) polymer or a fluoroethylenepropylene (FEP) polymer or a mixture thereof.

According to one especially preferred embodiment of the present invention the fluoropolymer is polytetrafluoroethylene (PTFE) polymer (Teflon®) or a mixture of polytetrafluoroethylene (PTFE) polymer (Teflon®) and another fluoropolymer. Teflon® is the DuPont trademark for polytetrafluoroethylene (PTFE), a polymer (plastic) with physical properties making it slippery (low friction). Teflon® was invented in the year of 1938 by Roy J Plunkett, then working at DuPont. The first commercial products were produced in the forties and in the fifties Teflon® became widely known. Teflon® is first and foremost known to be used in frying pans to prevent food from sticking to the pan.

As mentioned above, with a fluoropolymer coating to the inner surface of the brass portafilter according to the present invention, the taste of the finished coffee product, espresso, is improved in comparison to when a brass portafilter according to state of the art is used. The improvement in taste is due to the fact that corrosion is prevented with the present invention. Moreover, when espresso (water/steam/coffee) is in contact with the fluoropolymer coating, in principal no problems with ion precipitation out into the finished espresso will occur. This is not the fact when espresso is in contact with brass, as is the case with a brass portafilter according to state of the art. The finished coffee product, i.e. espresso, when a portafilter according to the present invention is used, has a smoother and more full-bodied original coffee taste. The most noticeable difference in any espresso when using a portafilter according to the present invention is the lack of acerbity or metallic taste in the espresso. This acerbity is something that is present in all scenarios using a brass or red copper portafilter according to state of the art due to the corrosion of the brass and/or ions precipitating.

Although smaller amounts of some metals are not harmful to man, for people drinking a lot of coffee and espresso it should also be healthier to drink espresso with only small amounts of metal ions or in principal no amounts at all, as is the case when drinking espresso made with a portafilter according to the present invention. In the case of the portafilter according to the present invention, the only possible metal ions come from the water fed to the espresso machine or from the original coffee. That is not the case when a brass portafilter according to state of the art is used.

Another advantage of the portafilters according to the present invention is the decreased deposition of the inside of the portafilters, hence they do not have to be cleaned as often and the procedure is easier to perform, and the taste is also not affected as much from “used” coffee particles which have deposited on the inside of the portafilter, as is the case of brass portafilters according to state of the art.

It should also be possible to use other polymer materials than fluoropolymers as the outer layer of the inside of the portafilter, but it is important in that case that these polymer materials are accepted in food applications and that they are possible to attach to the inside of the portafilter, e.g. by the use of a suitable primer. Some of these polymers could be lower in cost in comparison to fluoropolymers, but they do not have the same beneficial effects all together as the fluoropolymers according to the present invention in these applications, that is in relation to how they attach to a brass portafilter by use of a primer and how the taste of the finished espresso is affected. Moreover, fluoropolymers are low friction materials and therefore other materials, in this case fat, cellulose and coffee particles from the coffee, do not stick as easily to these fluoropolymers in comparison to other polymer materials. That is, as mentioned, the reason why cleaning does not have to be performed as often and is an easier procedure with portafilters according to the present invention in comparison to brass portafilters according to state of the art.

The primer is essential to be able to achieve an attachment of the fluoropolymer coating to the inner surface of the portafilter according to the present invention. Primers are e.g. used industrially today in painting techniques as ground coats, i.e. as surface treatments of products that is to be painted with several layers of paint. Primers often contain additives which improve adhesion, gives corrosion protection etc. This could of course be the case with the primers according to the present invention as well.

According to one preferred embodiment of the present invention, the layer of primer is a slurry sprayed inorganic layer or a plasma sprayed inorganic layer or a combination thereof. What is achieved by using a slurry spraying technique or a plasma spraying technique or a combination thereof is that primer particles or a layer of primer is sprayed onto the brass inside of the portafilter. Imbedded in the brass surface the primer works like an anchor interacting with the fluoropolymer. When this is performed it looks like a shower of sparks. The layer of primer is irregular, and some of the projecting tops are grounded down in order to get a correct attachment. Blasting is also something that can be used to treat the layer of primer in this sense. Then, the layer of fluoropolymer is filled on top of the layer of primer, and these two layers interact in symbiosis with each other, which fact creates a very good attachment of the layer of fluoropolymer. In other words, the two layers interact with a locking effect with each other. Without the primer according to the present invention it is not possible to achieve a fluoropolymer coating of the brass inner surface of the portafilter that will stay attached to the inner surface. In other words, to achieve a strong adhesion of the fluoropolymer coating to the brass inner surface, a primer has to be used.

According to one preferred embodiment of the present invention the primer is made of a ceramic material.

According to another preferred embodiment of the present invention the primer is a metal, metal alloy or a metallic material.

According to yet another preferred embodiment of the present invention the primer comprises iron (Fe) or an alloy thereof.

According to one preferred embodiment of the present invention the primer comprises steel or an alloy thereof.

According to still one preferred embodiment of the present invention the primer comprises stainless steel or an alloy thereof.

According to another preferred embodiment of the present invention the primer comprises copper (Cu) or an alloy thereof.

According to yet another preferred embodiment of the present invention the primer comprises aluminium (Al) or an alloy thereof.

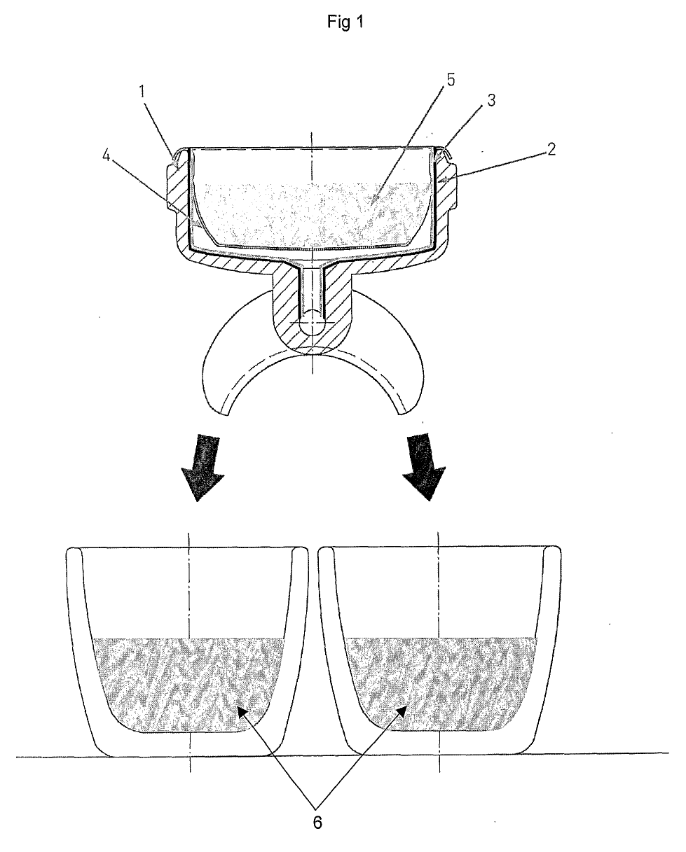

The mentioned specific embodiments of the invention and the example illustrated in FIG. 1 should be perceived just as such, and not as limiting the scope of the invention. The scope of the invention is defined by the enclosed claims.

1-12. (canceled)

13. Portafilter for an espresso machine, which portafilter is made of brass and comprises an inner surface, wherein the inner surface of the portafilter is coated first with a layer of primer and then a layer of fluoropolymer, wherein the layer of primer enables attachment of the layer of fluoropolymer to the inner surface of the portafilter.

14. Portafilter according to claim 13, wherein the fluoropolymer is accepted to be used in food applications.

15. Portafilter according to claim 13, wherein the fluoropolymer is chosen from the group consisting of a polytetrafluoroethylene (PTFE) polymer, perfluoroalkoxy (PFA) polymer or a fluoroethylenepropylene (FEP) polymer or a mixture thereof.

16. Portafilter according to claim 15, wherein the fluoropolymer is polytetrafluoroethylene (PTFE) polymer (Teflon®) or a mixture of polytetrafluoroethylene (PTFE) polymer (Teflon®) and another fluoropolymer.

17. Portafilter according to claim 13, wherein the layer of primer is a slurry sprayed inorganic layer or a plasma sprayed inorganic layer or a combination thereof.

18. Portafilter according to claim 13, wherein the primer is made of a ceramic material.

19. Portafilter according to claim 13, wherein the fluoropolymer is chosen from the group consisting of a polytetrafluoroethylene (PTFE) polymer, perfluoroalkoxy (PFA) polymer or a fluoroethylenepropylene (FEP) polymer or a mixture thereof and the primer is made of a ceramic material.

20. Portafilter according to claim 13, wherein the fluoropolymer is polytetrafluoroethylene (PTFE) polymer (Teflon®) or a mixture of polytetrafluoroethylene (PTFE) polymer (Teflon®) and another fluoropolymer and the primer is made of a ceramic material.

21. Portafilter according to claim 13, wherein the primer is a metal, metal alloy or a metallic material.

22. Portafilter according to claim 13, wherein the fluoropolymer is chosen from the group consisting of a polytetrafluoroethylene (PTFE) polymer, perfluoroalkoxy (PFA) polymer or a fluoroethylenepropylene (FEP) polymer or a mixture thereof and the primer is a metal, metal alloy or a metallic material.

23. Portafilter according to claim 13, wherein the fluoropolymer is polytetrafluoroethylene (PTFE) polymer (Teflon®) or a mixture of polytetrafluoroethylene (PTFE) polymer (Teflon®) and another fluoropolymer and the primer is a metal, metal alloy or a metallic material.

24. Portafilter according to claim 21, wherein the primer comprises iron (Fe) or an alloy thereof.

25. Portafilter according to claim 21, wherein the primer comprises steel or an alloy thereof.

26. Portafilter according to claim 21, wherein the primer comprises stainless steel or an alloy thereof.

27. Portafilter according to claim 21, wherein the primer comprises copper (Cu) or an alloy thereof.

28. Portafilter according to claim 21, wherein the primer comprises aluminium (Al) or an alloy thereof.

29. Portafilter according to claim 13, wherein the layer of primer is a slurry sprayed inorganic layer or a plasma sprayed inorganic layer or a combination thereof and the primer comprises steel or an alloy thereof.

30. Portafilter according to claim 13, wherein the layer of primer is a slurry sprayed inorganic layer or a plasma sprayed inorganic layer or a combination thereof and the primer is made of a ceramic material.
